(19) United States
(12) Patent Application Publication
(10) Pub. No.: US 2004/0101609 A1
(43) Pub. Date: May 27, 2004

(54) Apparatus for perforating food crop seed, and method

(76) Inventors: Gary E. Mulder, Grand Rapids, MI (US); Kevin J. Young, Byron Center, MI (US)

Correspondence Address: PRICE HENEVELD COOPER DEWITT & LITTON, LLP, 695 KENMOOR, S.E., P O BOX 2567, GRAND RAPIDS, MI, 49501, US

(21) Appl. No.: 10/304,313

(22) Filed: Nov. 26, 2002

(51) Int. Cl. A01J 1/00

(52) U.S. Cl. 426/518

(57) ABSTRACT

An apparatus for continuous perforating of an outer layer of food crop seeds includes a transporter including a seed loading station, a blasting station, a blow-off station, and a seed unloading station. The transporter further includes a plurality of chambers movable between the stations for continuously supplying known quantities of selected food crop seeds to be processed at each station, and a blasting device positioned at the blasting station and configured to continuously perforate an outer layer on the selected food crop seeds. A recycling device is positioned at the blow-off station and is adapted to collect and recycle the perforating agent.

### BACKGROUND OF THE INVENTION

The present invention relates to an apparatus and method for perforating food crop seeds, and more particularly relates to an automated apparatus adapted to continuously perforate an outer layer of seeds or similar articles.

Published application Ser. No. 09/758,663, filed Jan. 11, 2001, entitled PROCESS FOR INCREASING THE RATE OF HYDRATION OF FOOD CROP SEEDS, discloses that the amount of time required to hydrate food crop seeds can be substantially reduced by perforating their outer layer(s). Further, the nutritional value of the food crop seed can be improved by keeping the outer layer, instead of removing it. The application suggests various ways of perforating the outer layer of the seeds. In one example, rice seed was placed on standard mesh screens and blasted with high pressure (approx. 90 psi) carrying sand, salt, or parboiled rice flour at high velocity. The screen was held at an angle and agitated in such a manner that all sides of the rice were randomly exposed to the particles.

However, the '663 application does not give any details of how to make a production apparatus for continuous perforation of seeds. Nor are specific concerns addressed, such as how to make the process controllable, repeatable, practical, continuous, and automatic (as opposed to inconsistent, unrepeatable, inefficient, performable only in batches, and manually intensive). Nor is any specific apparatus disclosed that is capable of uniformly perforating the outer layer of large amounts of seeds, while also handling and collecting the large amount of perforating particles that will necessarily be used. It is particularly difficult to uniformly perforate the outer layer of a large amount of seeds. For example, when perforating the outer layer of a large volume of seeds, many seeds may have their outer layer abraded away, while other seeds may have outer layers that are not satisfactorily perforated (or are not perforated at all). An important part of perforating the outer layer is to leave as much of the outer layer as possible, since a large number of nutrients are found in the outer layer. Where the perforation is non-uniform, the seeds with their outer layers abraded away will cook “too fast”, while the seeds with their outer layers intact (i.e. not perforated) cook “too slow”, thus leaving an undesirable mix of seeds that cannot be cooked to a uniform and consistently soft state. Further, it is impractical to have enough perforating agent (i.e. “blasting abrasive”) to perforate a high volume of seed. In other words, a recapture and recycling system is desired, which is not taught in the '663 application.

Another problem is that seed flour that is sufficiently fine to act as a good perforating agent can be difficult to handle. For example, fine rice flour is an excellent perforating agent in many circumstances, but it has a tendency to bunch and cake up if it comes into contact with oil or moisture. Where the rice flour is used to perforate outer layers of rice seed, the rice flour will pick up oils from the rice seeds.

Another problem is dealing with the high volume of airflow needed to carry the perforating particles into contact with the rice seeds being treated. The seeds need to be contained without undesirably restricting a velocity of the airflow. This is necessary so that the perforating particles have enough velocity and kinetic energy to perforate the seed outer layers. The seeds also need to be mixed and agitated. However, this can result in excessive parts and pieces in the stream of food product, which can cause quality problems.

Still further, there is a need for a long-lasting apparatus that can withstand abrasion from perforating particles. The apparatus preferably should be low-cost, durable, and capable of sanitary, safe and automatic operation, and also flexible enough to be used with a variety of different seeds and perforating particle types and sizes. Where fine rice flour is used, there is a need to handle the rice flour in a manner that avoids clumping of the rice flour from oils from outer layers on seed, yet having the ability to re-use some or all of the rice flour. Further, the apparatus must provide some way of mixing or churning the rice so that all seeds are uniformly treated during the process.

Accordingly, an apparatus and method are desired having the aforementioned advantages and solving the aforementioned problems.

### SUMMARY OF THE PRESENT INVENTION

In one aspect of the present invention, an apparatus is provided for perforating an outer layer of food crop seeds using a perforating agent and a carrier substance. The apparatus includes at least one confinement chamber with at least one apertured sidewall, the apertured sidewall having apertures small enough to prevent loss of the selected food crop seeds to be processed, but the apertures being large enough to allow escape of the carrier and perforating agent. The apparatus further includes a blasting device configured to motivate a mixture of the carrier substance and the perforating agent into the one confinement chamber for perforating an outer layer of the selected food crop seeds.

In another aspect of the present invention, an apparatus for continuous perforating of an outer layer of food crop seeds includes a seed transporter for continuously supplying quantities of selected food crop seeds to be processed, and a blasting device positioned along the transporter and configured to continuously perforate an outer layer of the selected food crop seeds.

In yet another aspect of the present invention, an apparatus for continuous perforating of an outer layer of food crop seeds includes a transporter including a seed loading station, a blasting station, a blow-off station, and a seed unloading station. The transporter further includes a plurality of chambers movable between the stations for continuously supplying known quantities of selected food crop seeds to be processed at each station, and a blasting device positioned at the blasting station and configured to continuously perforate an outer layer on the selected food crop seeds. A blower is positioned at the blow-off station and adapted to blow off residual amounts of the perforating agent.

In another aspect of the present invention, a method for perforating an outer layer on food crop seeds comprises steps of providing a confinement chamber having at least one apertured sidewall, and placing a predetermined amount of food crop seeds in the chamber. The method further includes providing a blasting device configured to motivate a mixture of a carrier substance and a perforating agent into the confinement chamber for perforating an outer layer of the food crop seeds, and operating the blasting device to perforate the outer layer on the food crop seeds.

In yet another aspect of the present invention, a method for perforating an outer layer on food crop seeds comprises steps of continuously transporting bulk quantities of the food crop seeds past a blasting device adapted to perforate an outer layer of the food crop seeds. In a narrow form, the method includes placing controlled amounts of the food crop seeds within confined chambers, and/or oscillating a blasting gun on the blasting device.

These and other features, objects, and advantages of the present invention will become apparent to a person of ordinary skill upon reading the following description and claims together with reference to the accompanying drawings.

### BRIEF DESCRIPTION OF DRAWINGS

FIGS. 1-3 are front, side, and top views of a seed-blasting apparatus; and

FIG. 4 is a perspective view of the seed-transporting wheel of FIG. 1.

### DETAILED DESCRIPTION OF THE PREFERRED EMBODIMENT

The present disclosure is contemplated to be a complete and sufficient disclosure for a person of ordinary skill to understand and practice the presently described invention. However, the reader is encouraged to review the following published application for additional information—published application Ser. No. 09/758,663, filed Jan. 11, 2001, entitled PROCESS FOR INCREASING THE RATE OF HYDRATION OF FOOD CROP SEEDS, the disclosure of which application Ser. No. 09/758,663 is incorporated herein in its entirety.

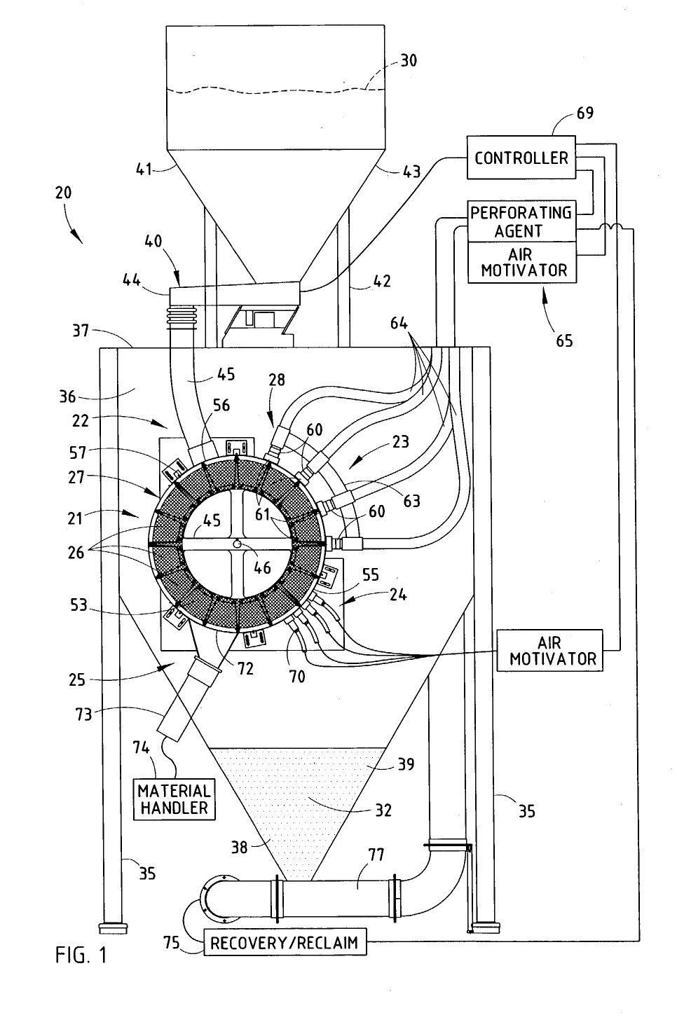

An apparatus 20 (FIG. 1) for continuous perforating of an outer layer of food crop seeds 30 includes a transporter 21 with a seed loading station 22, a blasting station 23, a blow-off station 24, and a seed unloading station 25. The transporter 21 further includes a plurality of chambers 26 on a rotatable wheel 27. The wheel 27 is rotatable to move seeds 30 between the stations 22-25 in a continuous process. By this arrangement, the transporter 21 continuously supplies known quantities of selected food crop seeds 30 in confined chambers 26 past a blasting device 28 at blasting station 23. The blasting device 28 propels a carrier (e.g. air) and a perforating agent 32 (e.g. a rice flour) into the chambers 26, with the blasting device 28 oscillating parallel to the center axis of the wheel 27 so as to mix and agitate the seeds 30 in each chamber during the blasting step. By this arrangement, the apparatus 20 continuously and uniformly perforates an outer layer on the selected food crop seeds 30. A blower 29 is positioned at the blow-off station 24, and is adapted to blow off residual amounts of the perforating agent 32.

The illustrated apparatus 20 (FIG. 1) includes an enclosure or cabinet defined by legs 35, sidewalls 36 and a top panel 37. Angled panels 39 are positioned in the cabinet to form a collection chute 38 for collecting used perforating agent 32. A seed loader/handler 40 is positioned on the top panel 37. The seed loader/handler 40 includes a seed-filled bin 41 with legs 42 and an angled chute-forming bottom 43 leading to a dispenser 44 for measuring predetermined amounts of seed fed down feed tube 45. It is contemplated that the dispenser 44 can be a vibratory or auger dispenser, or can be any of a variety of other devices for dispensing seeds at a controlled rate or volume. The dispenser 44 is controlled by a controller 69 or other control device, and can be intermittent or continuous, and is preferably adjustable for changing and controlling an amount and rate of seed dispensing into each of the chambers 26.

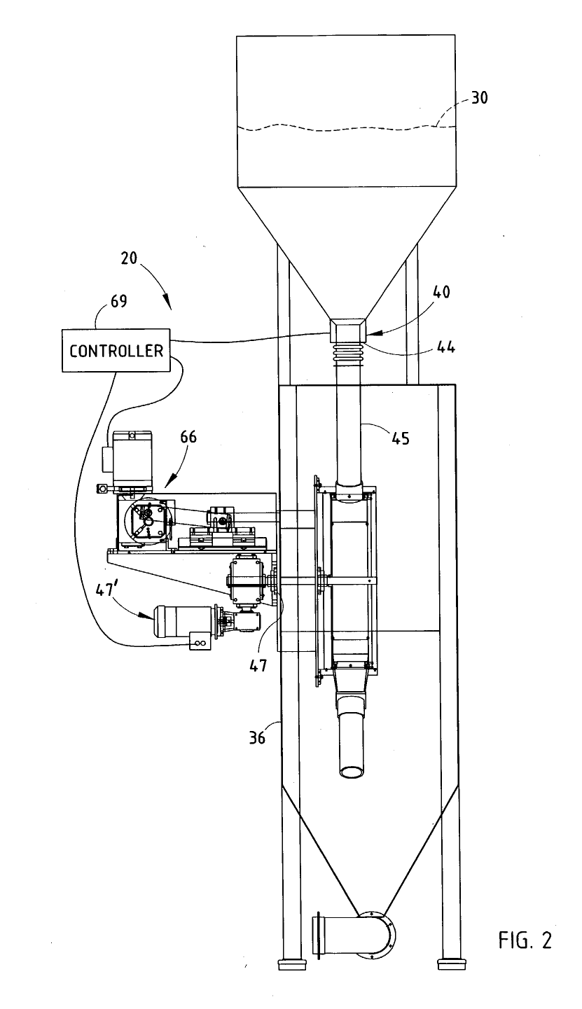

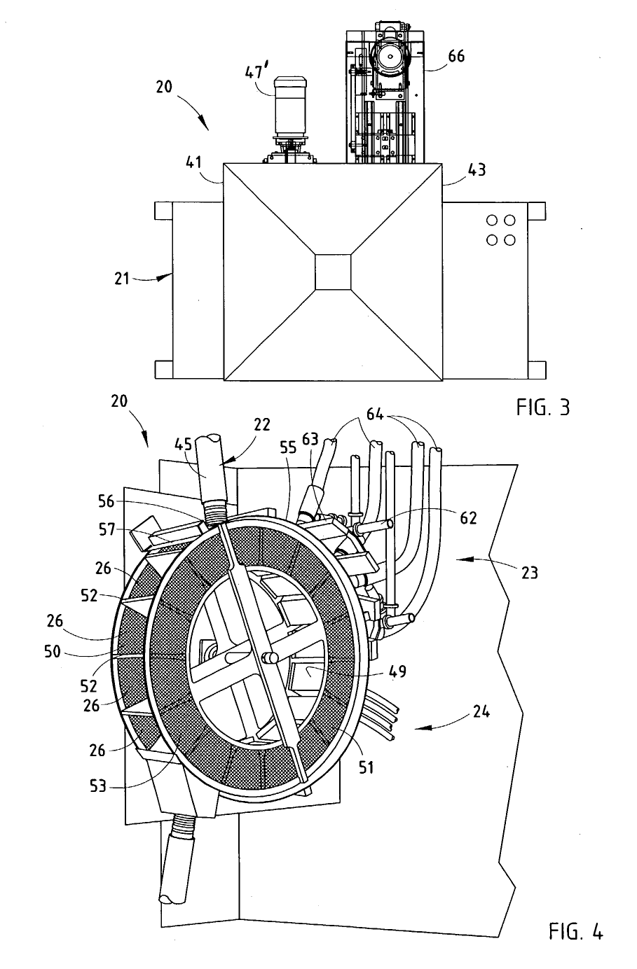

The transporter 21 includes the wheel 27. The illustrated wheel 27 has sixteen chambers 26 positioned around its circumference, although it may include more or less in number, as discussed below. The wheel 27 includes a ring formed by the chambers 26, and further includes spokes 45 (FIG. 1) that support the ring on an axle 46. The axle 46 is supported on the cabinet by one or more axle supports 47 (FIG. 2). The axle 46 extends outward of the cabinet sidewalls 36. A variable-speed drive mechanism 47′ is supported on the sidewall 36 by a bracket, and is operably attached to the axle 46 for rotating the wheel 27 at a controlled speed.

The chambers 26 (FIG. 4) each include a bottom wall 49, front and rear walls 50 and 51, and adjacent parallel walls 52. At least one of the walls 49-52 includes a plurality of small holes 53 therein, and in the illustrated chambers 26, all walls 49-52 have the holes 53. (As illustrated, the bottom walls 49 and adjacent walls 52 are not shown with holes 53, because it makes the drawing hard to read.) The holes 53 are sized small enough to retain the seeds being processed through the apparatus 20, but are large enough to allow the air carrier and perforating agent 32 out of the chambers 26 as new air carrier and new perforating agent 32 is pumped into a particular chamber 26.

The chambers 26 include a radially outwardly open top, but an arcuate stationary sealing plate 55 extends three-fourths of the way around the wheel 27 in a manner sealingly covering and closing the top of the chambers 26 when they are under the sealing plate 55. The sealing plate 55 includes an inlet hole 56 through which the down feed tube 45 passes newly-introduced untreated seed 30 into the chambers 26, and includes a leading end 57 that starts at least one chamber length ahead of the inlet hole 56 (so that seeds 30 do not spill during the chamber-filling step and so that the first blasting gun 60 does not blow seed out of the chambers 26). In the illustrated wheel 27, the leading end 57 is located at about 45° upstream from vertical, and about 22-½° upstream of the seed loading station 22. (See FIG. 1.)

The sealing plate 55 (FIG. 1) further extends around past the blasting station 23. The illustrated blasting station 23 includes four circumferentially-spaced blasting guns 60, and the sealing plate 55 includes transversely oriented slots 61 for each gun 60. A transverse guide support 62 (FIG. 4) operably supports the blasting guns 60 over each slot 61, and a gun carrier 63 is slidably connected to the guide support 62. A blasting gun 60 is attached to each gun carrier 63, and includes a supply tube 64 for communicating a mix of air carrier and perforating agent 32 to each gun 60. A source 65 capable of providing a good mix of air carrier and perforating agent 32 is connected to each supply tube 64. Such sources 65 are well known in the art and need not be described to a person of ordinary skill for an understanding of the present invention. Nonetheless, it is noted that the source 65 includes an air motivator, such as a blower, fan, or source of compressed air, and a dispenser for dropping known amounts of the perforating agent 32 into the air carrier. An oscillator drive mechanism 66 (FIG. 2) is operably connected to the gun carrier 63 for motivating the gun carrier 63 back and forth. By this arrangement, the blasting guns 60 are moved back and forth at a predetermined rate and distance optimally suited to create a churning and stirring action within the chambers 26 as the chambers 26 pass under the blasting guns 60 during rotation of the wheel 27. As illustrated in FIG. 1, the blasting station 23 begins about 45° after the seed inlet hole 56, and extends for about 70° around the wheel 27. Specifically, the illustrated blasting station 23 starts at about 22-½° down stream of the vertical position, and extends to a position about horizontally equal to the axle 46.

Shortly after the blasting station 23 is a blow-off station 24 where residual perforating agent 32 is blown off of the perforated seeds 30. The blow-off station 24 is spaced from the end of the blasting station 23 by slightly more than the length of a chamber 26, to prevent the blow-off station 24 from adversely affecting the blasting station 23. The blow-off station 24 includes a plurality of air nozzles 70 attached to the sealing plate 55. The air nozzles 70 are attached at holes in the sealing plate 55 and are oriented into the chambers 26 to blow off residue and excess perforating agent 32 from the seeds 30 contained in the chambers 26 as the seeds 30 are transported to the unloading station 25. The illustrated blow-off station 24 extends slightly more than the length of a single chamber 26 and includes four nozzles 70, but it is noted that the blow-off station 24 can be longer or shorter, or not included at all if it is not needed. The type of perforating agent 32 will greatly affect the parameters of the blow-off station 24.

The seed unloading station 25 is located at the vertical bottom position of the wheel 27, or slightly after the bottom. The sealing plate 55 extends past the unloading station 25, and includes an outlet aperture 72 connected to an angled down spout 73 that leads out of the cabinet to a material handling apparatus 74. Any of a number of different type material handling apparatus can be used, such as a fluidized air carrier, an auger, or other means. The material handling apparatus transports the perforated seed to a bag or container loading apparatus.

The apparatus 20 includes a collection and recycle device 75 for the perforating agent 32. The illustrated collection and recycle device 75 includes the angled panels 39 that are positioned in a bottom of the cabinet to form a collection chute 38 for collecting used perforating agent 32 escaping from the chambers 26. The bottom of the chute 38 forms a channel that funnels into a horizontal transport tube 77. Air funneled along the transport tube 77 picks up and fluidizes the falling/collected perforating agent 32, and transports it to a separator, such as a cyclone swirling separator, where the perforating agent is collected, dumped into a storage bin at the source 65 of the mix of air carrier 31 and perforating agent 32. A vibrator can be added to the angled panels 39 if needed to urge continuous non-bunching flow of the perforating agent 32. New virgin perforating agent 32 can be added to the mix (automatically or manually), as needed.

Testing has shown that for the best perforating results for most food crop seeds, the chambers 26 should be filled to a surprising and unexpectedly high level. Specifically, testing has shown that, in the illustrated apparatus 20, the chambers 26 should be filled to greater than 50%, and more preferably filled to about 66% to 85%, and most preferably should be filled to about 70% to 75%. The rotation of the wheel 27 and the oscillation of the blast guns 60 can significantly affect this process, since they affect the total blasting time and the turbulence within the chambers 26. Also, the hardness of the outer layer of the seed 30 can affect this. Also, a shape of the chambers 26 greatly affects the agitation and churning of the seeds within the chambers 26. It has been found that a “square box” shape is preferable, where the height, width, and depth of the chamber are all about equal. Chamber shapes that have a thin dimension or flat shape can tend to cause the blast guns to blow columnar holes through the body of seeds contained within the thin chamber, rather than cause the seeds to churn. Also, wedge-shaped chambers can cause the seeds to pile up and can unacceptably reduce agitation of the seeds 30. It is noted that the wheel 27 is large enough so that, even though the walls 52 are angled, they are sufficiently close to the “square box” shape to be effective. The speed of rotation of the wheel 27 and the oscillation speed of the blast guns 60 can also affect the tendency to blow holes through the body of seeds in a chamber. The illustrated chambers 26 seal quite tightly against the sealing plate 55, such that the seeds 30 within a given chamber 26 are well-contained and trapped, and the air carrier and perforating agent 32 are forced to disperse throughout the chambers 26 in order to exit through the small holes 53 in the sides and bottom of the chambers 26. This results in good stirring and agitation, since the seeds 30 themselves are fluidized by the air carrier 31 as it enters the chambers 26. Nonetheless, it is specifically contemplated that different shaped chambers can be used in the present apparatus 20.

A controller 69 (FIGS. 1-2) controls speeds and operating parameters of one or more of the following: the drive mechanism 47′ for the wheel 27, the drive mechanism 66 for the blasting gun oscillation, the seed dispenser 44, the volume and mix of air carrier and perforating agent 32 coming from the source 65, the blow-off nozzles 70, the recycle device 75, and any other devices of the system requiring control. It is noted that where the apparatus 20 is desired for a single specific use, many of the controller functions can be preprogrammed into an automatic start-up and shut-down routine, including variation and adjustment of the machine in response to different operating parameters. Alternatively, where the apparatus 20 will be used on many different seed types, or the seed quality or characteristics vary, the apparatus can include manual or automatic adjustability to cope with variations. Also, for example, it is contemplated that different wheels having different shapes and outlet hole sizes can be provided, allowing the apparatus to be quickly changed over to process other products. Notably, the items 69, 47′, 66, and 44 are located outside the cabinet 36/37 to separate them from the perforating agent (and to keep the process and seeds more sanitary and clean). It is noted that the apparatus 20 can recycle all of the flour perforating agent, or maybe set up to only recycle a percentage while blending new flour with the used flour each time, or it may be set up to not recycle any of the flour perforating agent at all.

In operation, the wheel 27 is rotated as seeds 30 are measured and dropped through the down feed tube 45 through inlet hole 56 into the chambers 26 as the chambers 26 pass under the inlet hole 56. Each chamber 26 is filled to about 75%. As the “filled” chambers 26 move past the oscillating blasting guns 60, the seeds 30, now captured in the chambers 60 by the sealing plate 55, are fluidized and agitated, and also bombarded by perforating agent 32, with the excess perforating agent 32 and air carrier being mostly blown out the holes 53 in the sides and bottom of the chambers 26. Any residue perforating agent 31 remaining after the chambers 26 pass the blasting station 23 are removed at the blow-off station 24. The treated seed 30, now having perforations blasted into its outer layer, is dropped through outlet aperture 72 at the unloading station 25, which conveys the treated seed to a packaging or storage site. Perforating agent 32 is collected by device 75 and recycled.

Based on testing, using four nozzles, for example, with chambers that were slightly less than 150 cu. inches (i.e. 135 in³) it is contemplated that over 1,000 lbs/hour of rice could be processed effectively with their outer layer being satisfactorily perforated. It is contemplated that with additional blasting guns, chambers, and etc, that additional tonnage per hour could be achieved. These kinds of projected production volumes clearly show that the concepts of the present invention can be expanded to satisfy many different production needs. It is specifically contemplated that the present inventive concepts are not limited to just a wheel-based system. Instead, it is contemplated that a scope of the present invention includes linear conveyor-based systems as well. It is noted that capturing of the seed in well-filled chambers has proved to be a highly effective and desirable feature in the present apparatus.

### EXAMPLE

Basmati rice, a variety of brown rice, was treated using an apparatus similar to the apparatus 20. The wheel speed was maintained at about 0.20 rpm. The wheel included sixteen baskets (i.e. chambers), with the size of each basket being about 135 cubic inches. The baskets each had a relatively square cubic shape, with basically equal dimensions in height, width, and depth directions. The baskets had their sides and bottoms made of heavy screen material, with holes small enough to retain the rice and prevent plugging by the rice, but large enough to permit rice flour to escape along with the air carrier. The quantity of rice in each basket was about 2.5 lbs, which made the baskets about ⅔ to ¾ full. The net rate of rice blasting with two pneumatic nozzles was about 480 lbs/hr, with a nozzle orifice size of about ¼ inch bore and an air pressure of about 45 psi. The nominal rice flour particle size was 80 mesh (i.e. about 0.008″), and the rice flour flow rate through each nozzle was about 5.2 lbs/minute. The nozzle oscillation speed was about 250″/minute, and the nozzle stroke length was 5″.

The present apparatus are believe to be particularly useful for perforating food product seeds, but also are believed to be useful for perforating the covering of any food product, such as to permit better penetration of the food product by water or the like. Further, the present apparatus is particularly suited for processes where sanitation and control over the blasting environment must be closely controlled, and where product must be agitated and stirred during the blasting process.

In the foregoing description, it will be readily appreciated by persons skilled in the art that modifications may be made to the invention without departing from the concepts disclosed herein. Such modifications are to be considered as included in the following claims, unless these claims by their language expressly state otherwise.

The invention claimed is:

1. An apparatus for perforating an outer layer of food crop seeds using a perforating agent and a carrier substance, comprising:
at least one confinement chamber with at least one apertured sidewall, the apertured sidewall having apertures small enough to prevent loss of the selected food crop seeds to be processed, but the apertures being large enough to allow escape of the carrier and perforating agent; and
a blasting device configured to motivate a mixture of the carrier substance and the perforating agent into the at least one confinement chamber for perforating an outer layer of the selected food crop seeds.

2. The apparatus defined in claim 1, wherein the at least one confinement chamber includes a plurality of additional confinement chambers.

3. The apparatus defined in claim 1, including a fill station, a blasting station, and an unload station, and including a transporter for transporting the confinement chamber sequentially past the stations.

4. The apparatus defined in claim 3, including a blow-off station for blowing off residual perforating agent from processed seeds.

5. The apparatus defined in claim 1, including a wheel supporting the at least one confinement chamber.

6. The apparatus defined in claim 1, wherein the confinement chamber has a cubic shape with height, width and depth dimensions being about the same.

7. The apparatus defined in claim 1, wherein the at least one chamber and blasting device are configured and arranged for continuous processing of seeds.

8. The apparatus defined in claim 1, wherein the blasting device includes at least one blasting gun and includes an oscillator device for oscillating the blasting gun.

9. The apparatus defined in claim 1, wherein the blasting device transmits enough air carrier to fluidize and agitate the seed in the at least one confinement chamber.

10. The apparatus defined in claim 1, including a loading station with a measuring device that fills the at least one chamber to at least 50% full.

11. The apparatus defined in claim 10, wherein the measuring device fills the at least one chamber to at least about 66% to 85% full.

12. The apparatus defined in claim 1, wherein the at least one chamber has a volume about equal to 150 cubic inches or less.

13. The apparatus defined in claim 1, including a recovery device for recovering used perforating agent.

14. An apparatus for continuous perforating of an outer layer of food crop seeds using a perforating agent and a carrier substance, comprising:
a seed transporter for continuously supplying quantities of selected food crop seeds to be processed; and
a blasting device positioned along the transporter and configured to continuously perforate an outer layer of the selected food crop seeds.

15. The apparatus defined in claim 14, wherein the blasting device includes at least one blasting gun and includes an oscillator device for oscillating the blasting gun.

16. An apparatus for continuous perforating an outer layer of food crop seeds using a perforating agent and a carrier substance, comprising:
a transporter including a seed loading station, a blasting station, a blow-off station, and a seed unloading station, the transporter further including a plurality of chambers movable between the stations for continuously supplying known quantities of selected food crop seeds to be processed at each station;
a blasting device positioned at the blasting station and configured to continuously perforate an outer layer on the selected food crop seeds; and
a blower positioned at the blow-off station and adapted to blow off residue amounts of the perforating agent.

17. The apparatus defined in claim 16, wherein the blasting device includes at least one blasting gun and includes an oscillator device for oscillating the blasting gun.

18. A method for perforating an outer layer on food crop seeds comprising steps of:
providing a confinement chamber having at least one apertured sidewall;
placing a predetermined amount of food crop seeds in the chamber;
providing a blasting device configured to motivate a mixture of a carrier substance and a perforating agent into the confinement chamber for perforating an outer layer of the food crop seeds; and
operating the blasting device to perforate the outer layer on the food crop seeds.

19. The method defined in claim 18, wherein the step of operating a blasting device includes oscillating a blasting gun.

20. A method for perforating an outer layer on food crop seeds comprising steps of:
continuously transporting bulk quantities of the food crop seeds past a blasting device adapted to perforate an outer layer of the food crop seeds.

21. The method defined in claim 20, wherein the step of continuously transporting includes placing known amounts of the food crop seeds into chambers with known volumes.

22. The method defined in claim 20, including automatically oscillating the blasting device as the food crop seeds are transported past the blasting device.
